(19) United States
(12) Patent Application Publication
(10) Pub. No.: US 2012/0121469 A1
(43) Pub. Date: May 17, 2012

(54) Pressurized Acoustic Resonator With Fluid Flow-Through Feature

(75) Inventors: Robert Hiller, Saint Anthony, CA (US); Joel Gutierrez, Grass Valley, CA (US); D. Felipe Gaitan, Nevada City, CA (US)

(73) Assignee: IMPULSE DEVICES INC., Grass Valley, CA (US)

(21) Appl. No.: 13/294,574

(22) Filed: Nov. 11, 2011

Related U.S. Application Data
(60) Provisional application No. 61/412,591, filed on Nov. 11, 2010.

(51) Int. Cl. B06B 1/00

(52) U.S. Cl. 422/117; 422/119

(57) ABSTRACT

Acoustic resonators and systems for controlling the same to cause desired reactions and physical effects therein are described. Some aspects are directed to an acoustic cavitation resonator that can be placed under high static pressure and to which a set of ultrasonic drivers are coupled so as to cause cavitation in the resonator during operation. Inlet and outlet ports allow introduction of one or more fluid species into the resonator so that the desired processing of the fluids can be accomplished under pressure and in the presence of cavitation.

### TECHNICAL FIELD

The present application relates to resonators for applying acoustic energy to fluids contained therein. Specifically, the present application describes high-intensity acoustic resonator chambers, which may be used to apply acoustic energy to fluids flowing therethrough, and in some cases, flowing fluids under pressure, and in other cases, applying acoustic fields to cause cavitation within said fluids.

### BACKGROUND

It is known that acoustic fields can be applied to fluids (e.g., liquids, gases) within resonator vessels or chambers. For example, standing waves of an acoustic field can be generated and set up within a resonator containing a fluid medium. The acoustic fields can be described by three-dimensional scalar fields conforming to the driving conditions causing the fields, the geometry of the resonator, the physical nature of the fluid supporting the acoustic pressure oscillations of the field, and other factors.

One common way to achieve an acoustic field within a resonator is to attach acoustic drivers to an external surface of the resonator. The acoustic drivers are typically electrically-driven using acoustic drivers that convert some of the electrical energy provided to the drivers into acoustic energy. The energy conversion employs the transduction properties of the transducer devices in the acoustic drivers. For example, piezo-electric transducers (PZT) having material properties causing a mechanical change in the PZT corresponding to an applied voltage are often used as a building block of electrically-driven acoustic driver devices. Sensors such as hydrophones can be used to measure the acoustic pressure within a liquid, and theoretical and numerical (computer) models can be used to measure or predict the shape and nature of the acoustic field within a resonator chamber.

If the driving energy used to create the acoustic field within the resonator is of sufficient amplitude, and if other fluid and physical conditions permit, cavitation may take place at one or more locations within a liquid contained in an acoustic resonator. During cavitation, vapor bubbles, cavities, or other voids are created at certain locations at times within the liquid where the conditions (e.g., pressure) at said certain locations and times allow for cavitation to take place.

For the sake of illustration, FIG. 1 shows a simplified diagram of an acoustic resonator or cavitation system 10 according to the prior art. A resonator 100 contains a volume of fluid which is to be cavitated. An acoustic driver such as a PZT transducer 110 is fixed to a location on cavitation chamber 100. The coupling is typically done by screw attachment or epoxy attachment of transducer 110 to chamber 100.

Transducer 110 is driven by an electrical driving signal generated by signal generator 120, which provides an output signal that is amplified by amplifier 130. The output of amplifier 130 is coupled to a conducting surface or electrode on transducer 110 to cause the transducer to vibrate, oscillate, or otherwise make an acoustic (e.g., ultrasonic) output. The acoustic output of transducer 110 is then transmitted to chamber 100 due to the acousto-mechanical coupling between transducer 110 and chamber 100.

Under certain conditions, the acoustic action of transducer 110 and chamber 100 set up an acoustic field within the fluid in chamber 100 that is of sufficient strength and configuration to cause acoustic cavitation within a region of chamber 100. Specifically, under suitable conditions, acoustic cavitation of the fluid in chamber 100 may cause bubbles 199 or acoustically-generated voids as described above and known to those skilled in the art, to form within one or more regions of chamber 100. The cavitation usually occurs at zones within the chamber 100 that are subjected to the most intense (highest amplitude) acoustic fields therein.

Acoustic resonator 100 has been designed in a variety of shapes and sizes, and has been used in a variety of applications in the art. For example, resonators made of glass and steel have been devised. Also, resonators having metal walls with glass or quarts optical viewing ports have been devised. Additionally, resonators in the shape of cylinders, spheres, and other shapes have been devised. Furthermore, flow-through resonator systems have been devised, where a flowing fluid passes through the resonator by entering in an inlet fluid port and exiting by an outlet fluid port.

However, previous resonator system designs have generally lacked utility and the design thereof has not been well-understood or optimally utilized. Traditional resonator systems rely on ad-hoc designs for the most part. The placement of the acoustic drivers on the resonators and the selection of the acoustic and fluid and ambient physical parameters and properties are also generally done in an ad-hoc way, and often rely of trial and error to achieve a desired outcome or semblance of an outcome. This is true in experimental laboratory settings as well as in industrial or biomedical applications, where persons designing and setting up the resonance system commonly rely on intuition or guesswork to implement the resonance systems.

It has not been possible or practical in the prior art to achieve large acoustic standing waves and high quality factors (Q) in acoustic resonators, especially those having flowing fluid therein. Also, such resonator systems have not been optimized for use in cavitation environments or environments where a flowing fluid is under static or ambient pressure.

### SUMMARY

Aspects of the present disclosure are directed to acoustic resonators containing a fluid such as a liquid which is both flowing and under some pressure. Embodiments hereof provide methods for generating cavitation at some or many locations within the resonators in a controlled way so as to accomplish a processing step carried out in the resonator on the fluids therein. Among other features, the selection of the location of the acoustic drivers, the inlet and outlet ports, and the other physical parameters of the system are discussed and collectively made to enhance the processing of the fluid medium or other substances carried therein. Applications of the present systems and methods can be found in industrial, environmental, biomedical, scientific, and other fields.

Some present embodiments are directed to an acoustic cavitation system, comprising an electrical driving circuit including a signal generator adapted to generate an electrical signal and an amplifier adapted to receive the electrical signal and generate an amplified driving signal for driving a plurality of transducer elements with respective driving signals at respective amplitudes thereof, a data processor coupled to said electrical driving circuit adapted for executing a sequence of programmed instructions and for controlling an operation of said electrical driving circuit, said plurality of transducer elements adapted to receive said respective driving signals and to provide respective acoustic outputs corresponding to the driving signals and amplitudes thereof, a resonator having resonator walls capable of withstanding a greater than ambient static pressure within said resonator, and comprising at least one fluid inlet port and at least one fluid discharge port, said resonator walls coupled to said plurality of transducer elements such that the acoustic outputs of said transducer elements cause an acoustic field in a volume defined by said resonator walls, and such that a given driving signal and amplitude configuration is adapted to cause cavitation within a fluid within said resonator, a fluid driving element adapted and arranged to cause flow of a fluid through said resonator, said flow being directed into at least one fluid inlet port of said resonator and exiting said resonator through at least one fluid discharge port, and a fluid pressure source adapted and arranged to cause a net positive static pressure within said resonator, operating cooperatively with said fluid driving element, such that a fluid flowing through said resonator experiences flow, pressure, and cavitation effects within said resonator in some or all of the volume defined by said resonator walls.

Other embodiments are directed to a cavitation system for causing cavitation in a cavitation chamber of said system, comprising a cavitation chamber having rigid walls thereof, a first fluid inlet port in an inlet volume of said chamber for receiving a first fluid or mixture, a second fluid inlet port in said inlet volume of said chamber for receiving a second fluid or mixture, a mixing zone in which said first and second fluids or mixtures are mixed with one another, a plurality of acoustic drivers coupled to said rigid walls of said chamber for causing cavitation in a cavitation zone within said cavitation chamber, said cavitation zone being substantially in a portion of said chamber in which said mixing zone is located, and at least one fluid outlet port in an outlet volume of said cavitation chamber for discharging the first and second fluids or mixtures after they have undergone mixing and cavitation.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates an acoustic resonator system according to the prior art;

FIG. 2 illustrates an exemplary cavitation system according to the present disclosure;

FIGS. 3-5 illustrate exemplary embodiments of acoustic cavitation chambers or resonators that take an incoming fluid or mixture through an inlet port and cavitate the same before discharging the fluids or mixtures through an outlet port and where the general direction of fluid flow is parallel to a long axis of symmetry of the chamber;

FIG. 6 illustrates an exemplary cavitation chamber that additionally allows mixing two or more fluids or mixtures therein, each entering through a respective inlet port;

FIG. 7 illustrates an exemplary cavitation chamber or resonator having a plurality of inlet ports and a plurality of outlet ports, and in which the direction of fluid movement is generally perpendicular to a long axis of symmetry of the chamber; and

FIG. 8 illustrates an exemplary cavitation chamber with a plurality of inlet and outlet fluid ports disposed at opposite ends thereof.

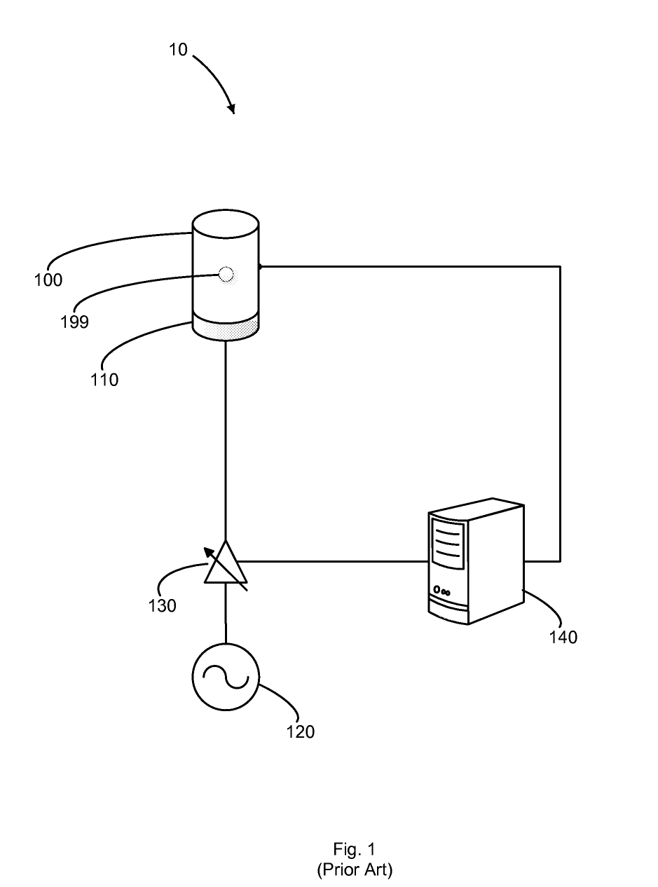

### DETAILED DESCRIPTION

As discussed above, it is useful to have acoustic resonators and chambers for conducting cavitation, which are equipped with flow-through capability to pass fluid through the resonator chamber. In addition, it is useful to have a well-designed resonator system for certain purposes, which may require controllable static pressure within the system, flow-through of a fluid medium, and custom or pre-configured or configurable acoustic driver placement.

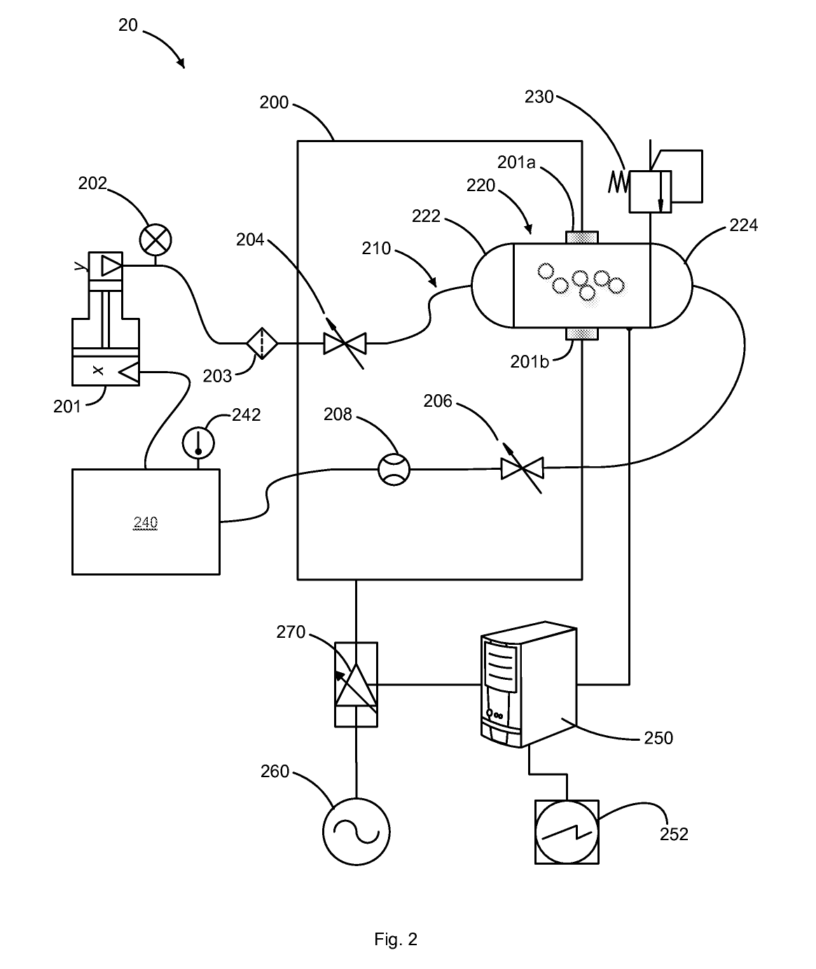

FIG. 2 illustrates an exemplary acoustic resonator and cavitation system 20. The system includes an electrical circuit 200 for driving the acoustic drivers 201a and 201b (which can be generalized to a plurality of acoustic drivers). The circuit is controlled by a controller or control processor or control computer 250. A signal generator or waveform generator 260 provides a signal that is amplified by amplifier 270, which is in turn computer-controlled by computer or processor 250. As mentioned earlier, the driving output of amplifier 270 provides the electrical stimulus to cause transduction within transducers 201a, b, which in turn cause acoustical field generation within resonator chamber 220.

The heavier lines of FIG. 2 represent a fluid circuit that circulates a fluid to be acoustically cavitated in resonator or chamber 220. The resonator 220 comprises a first end cap or end bell 222 at a first end thereof, and a second end cap or end bell 224 at a second end thereof. Said first and second ends of resonator 220 being substantially at opposite ends of said resonator 220 in some embodiments. Generally, a fluid is flowed in resonator 220, sometimes under static pressure, and said fluid may be cavitated by acoustic transducers 201a, b. As will be described further, the relative placement of the transducers and the fluid inlet and outlet ports in the system with respect to the acoustic field within the resonator 220 is arranged to achieve a desired outcome in processing the flowing pressurized fluid and/or materials suspended or dissolved therein.

The fluid circuit includes a fluid driver (e.g., a pump such as a rotary or reciprocating pump) 201. The pump 201 drives the fluid against the head loss in the fluid circuit portion of cavitation system 20. A pressure gauge 202 may be installed at a useful location downstream of pump 201 to monitor the pressure at its highest value downstream of pump 201. A filter 203 may be used inline with the flowing fluid to trap any impurities or dirt in the fluid.

A solenoid or gate valve 204 may be used to secure the fluid flow in some cases or to isolate the resonator upstream of the resonator 220. A second solenoid valve206 is used to secure flow of the fluid or to isolate the resonator 220 in cooperation with valve 204.

Relief value 230 may be provided as a safety mechanism to relieve fluid from the system if the pressure of said fluid exceeds a pre-determined threshold. For example, the relief valve may be set to discharge fluid in a controlled way if the pressure within resonator 220 approaches a value that could jeopardize the integrity of the resonator or other system components.

Fluid flow rate meter 208 may be used to sense and provide an indication of the rate of fluid flow (e.g., in cubic centimeters per second) through the fluid system. Because the fluid is generally incompressible, the fluid flow rate in the outlet portion of the system (as pictured) is substantially the same as the flow rate at the inlet to resonator 220.

A fluid holding, storage, surge or expansion tank or reservoir 240 is provided to contain an adequate amount of fluid and mediate any volumetric or pressure surges in the system. A temperature sensor (thermometer) 242 is used to provide an indication of the temperature of the fluid in the system.

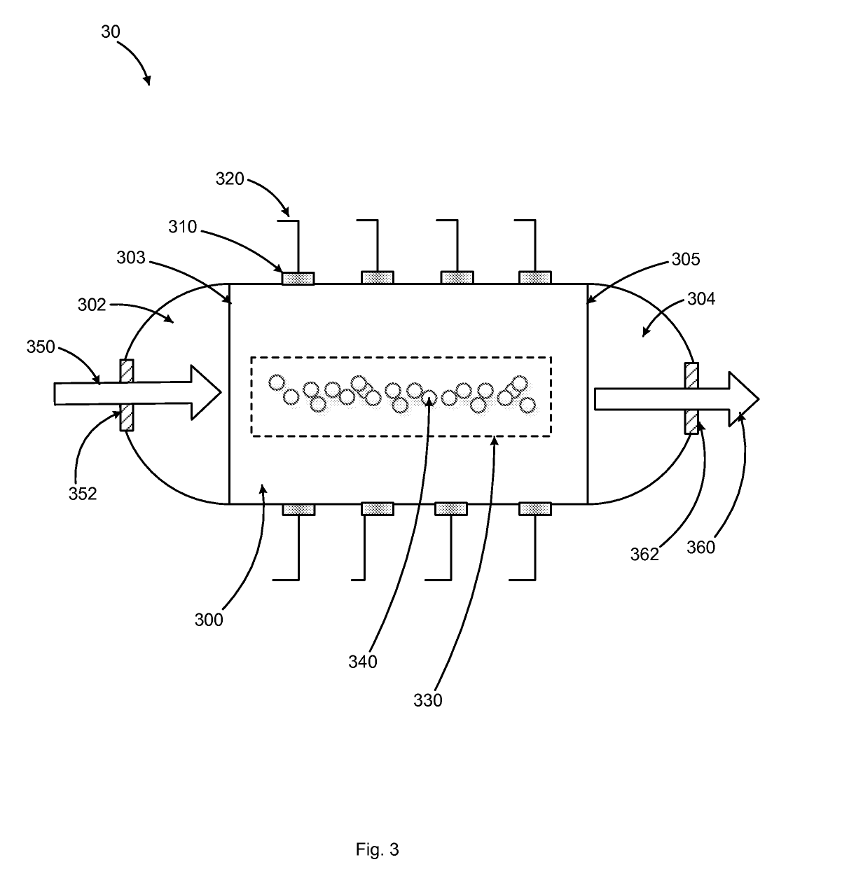

FIG. 3 illustrates another embodiment 30 or configuration of the present cavitation chambers. Liquid fluid 350 flows into an inlet volume 302 through an inlet port 352. A main cavitation volume 300 receives said incoming liquid 350 from the inlet volume 302. The main cavitation volume 300 of the chamber 30 may have a cylindrical shape and a generally circular cross section perpendicular to its cylindrical axis. The flow of liquid is generally to the right in FIG. 3 and qualitatively flowing substantially parallel to a cylindrical axial axis of symmetry of chamber 30, although it is to be understood that the flow may follow locally-variable paths and be subjected to turbulent movement at a local scale as well. The liquid 360 exits the chamber by flowing through exit volume 304 and out of the chamber from outlet port 362. The main cavitation volume 300 and the inlet and outlet volumes 302 and 304 may be formed as a single unit. Alternatively the three volumes may be formed by joining the inlet and outlet volumes 302, 304 to the central main volume 300 at joining locations 303 and 305. Joining locations 303 and 305 may be made by mechanically or otherwise coupling the various sections of cavitation chamber 30. These may be joined or coupled by a threaded or bolted mechanism, or by braising or welding, depending on the application so as to form a liquid seal to contain the liquid of interest within cavitation chamber 30.

As described earlier, numerous components may be connected to the cavitation chamber 30 forming a cavitation system having fluid and electrical parts, which are not all shown in FIG. 3 for simplicity. In addition, various coatings and surface treatments may be applied to the interior surfaces of the liquid-containing volumes of cavitation chamber 30 as needed to allow improved wetting of said surfaces for example. As discussed before, other materials, reactants, liquids, gases, or solids may be injected into or mixed with the primary cavitating fluid so that cavitation effects can operate on said mixed, dissolved, or entrained materials.

Cavitation chamber of FIG. 3 may be coupled to a plurality of acoustic drivers 310, which are in turn powered as discussed above by corresponding driving power connections 320. The plurality of acoustic drivers 310 may be driven with a common (shared) driving signal through connections 320 to each of the respective drivers or transducers 310, or each driver or transducer 310 may receive a unique and respective driving signal, or groups of drivers or transducers 310 may be grouped and each group thereof driven as a whole using a same or similar driving signal. In operation, piezo-electric ultrasound transducer elements 310 may be driven in a way to cause a desired cavitation condition within the liquid contained in or moving through volume 300 of the cavitation chamber 30. Of course, the cavitation may take place in a cavitation zone 330 that can include some or all of the interior volume of portion 300 of said chamber, depending on the design, driving and operational conditions. A plurality of cavitation bubbles 340, voids, or bubble clouds or bubble groups may be caused to form in cavitation zone 330 of chamber 30. The bubbles 330 may be convected or move with a fluid flow as the fluid passes from inlet port 352 to outlet port 362 of chamber 30.

In some embodiments, cavitation zone 330 extends to about a certain radius about the axial axis of the cylindrical cavitation chamber, and may extend in length to a certain length along said axis of the chamber. While not necessarily exactly cylindrical in shape, the cavitation zone formed hereby may take a general shape if averaged over time that resembles a cylindrical volume or a capsule shaped volume or elongated egg volume within the cavitation chamber's overall fillable volume. In some specific embodiments, the cavitation zone 330 is greater in volume than five percent (5%) of the volume of the cavitation chamber. In other embodiments, the cavitation zone has a volume greater than ten percent (10%) of the volume of the cavitation chamber. In yet other embodiments the cavitation zone has a volume greater than twenty five percent (25%), fifty percent (50%), or even greater than seventy five percent (75%) of the volume of the cavitation chamber. Finally, the cavitation zone may be made to include greater than ninety percent (90%), or substantially the entirety of the volume of the cavitation chamber.

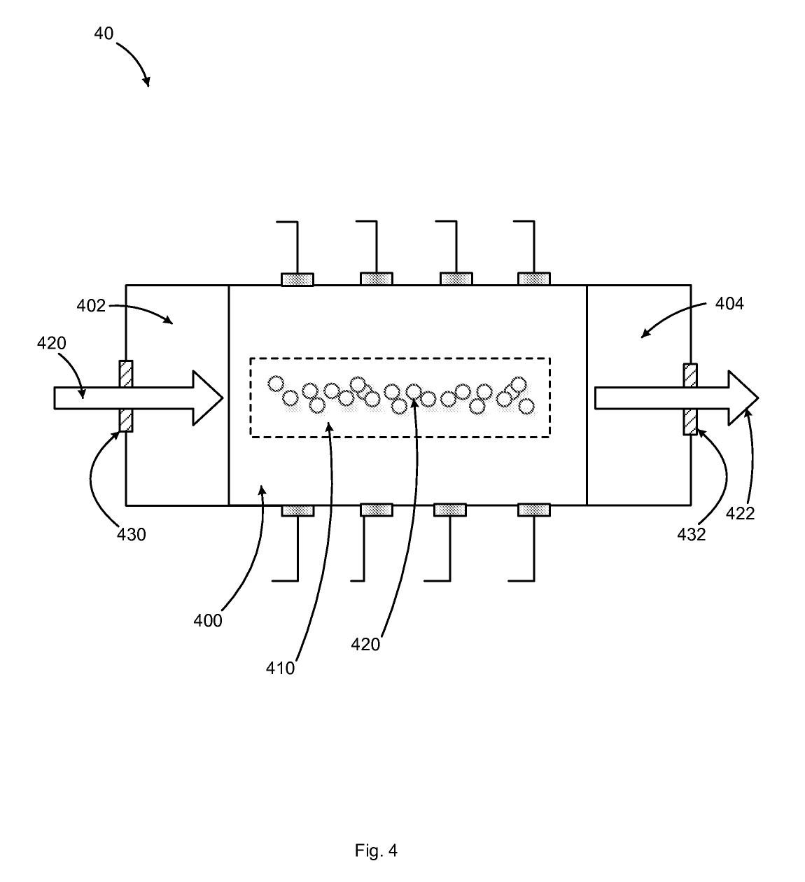

FIG. 4 illustrates another exemplary embodiment of a cavitation chamber 40 having a main cavitation section or volume 400 and an inlet section 402 and an outlet section or volume 404. The features and operation of cavitation chamber 40 are substantially similar to those described above with respect to chamber 30 of FIG. 3. However, in the chamber of FIG. 4, the end volumes 402 and 404 have a generally cylindrical shape so that their ends are substantially flat rather than curved as in the previous figure. Fluid 420 enters the inlet section 402 through an inlet port 430 and exits at 422 through discharge port 432 from exit volume 404. The fluid in the main volume 400 undergoes cavitation in some volume 410. It should be understood that cavitation bubbles 420 will mainly form in cavitation volume 410, but the nature of this phenomenon is that some cavitation events could occur in other portions of the fluid volume. The actual location of the volume where most of the cavitation takes place is in practice determined by the design of the cavitation chamber 40, the fluids therein, and the placement and driving of the acoustic transducers.

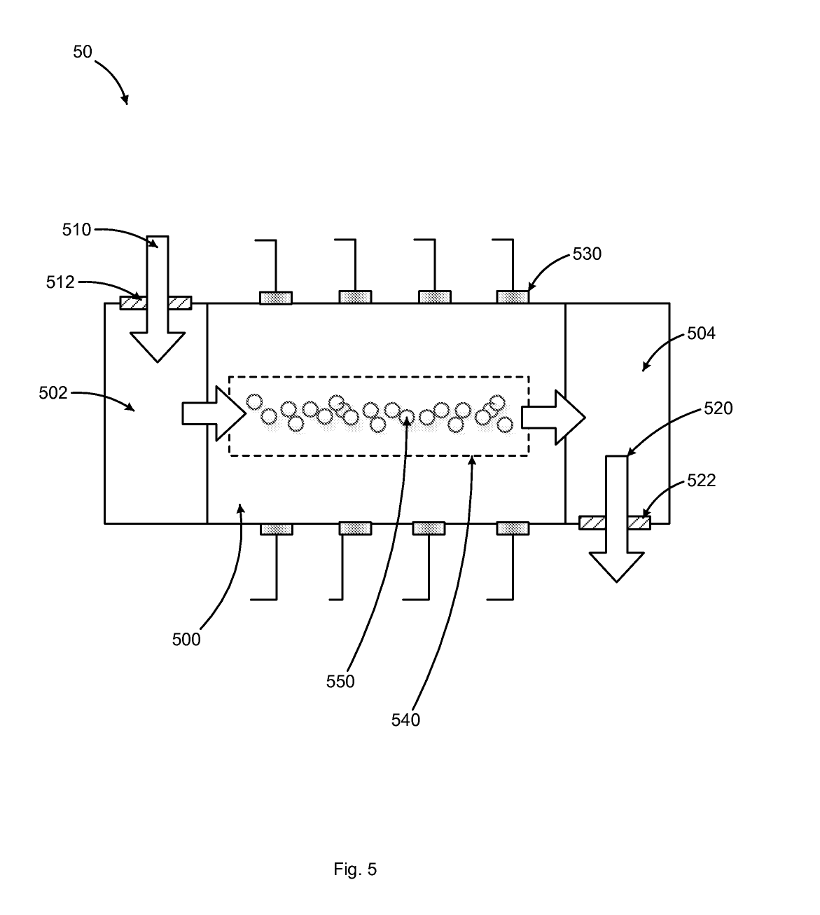

FIG. 5 illustrates another cavitation chamber 50 having a main cavitation volume 500 having inlet and outlet volumes 502 and 504 respectively. The incoming fluid 510 is received through inlet port 512 and the exiting fluid 520 exits through discharge port 522. The flow of fluid in chamber 50 is therefore generally from left to right in FIG. 5. Note that in the present embodiment, the fluid ports 512 and 522 are not disposed in the respective end walls of their inlet and outlet volumes 502 and 504. Instead, the fluid ports 512 and 522 are disposed in a side wall of volumes 502 and 504 respectively. Cavitation primarily takes place in a cavitation zone 540 that then develops cavitation bubbles 550.

A positive pressure may be applied to the cavitation system 50 by pressurizing the fluid system, e.g., by using a pump as shown earlier in FIG. 2. In this embodiment, the flow generally moves parallel to (along) the long axis of symmetry of the cavitation chamber.

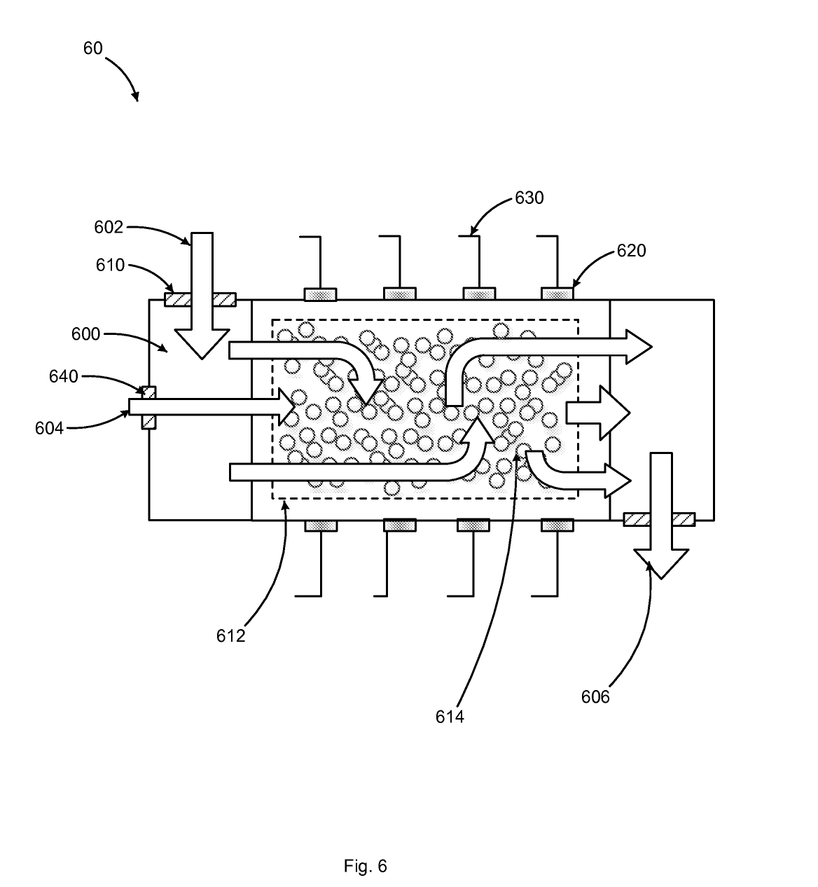

FIG. 6 illustrates a cavitation chamber 60 that allows cavitation in a cavitation zone 612 to generate cavitation bubbles 614 and other cavitation related phenomena. A first fluid 602 is input through a first inlet port 610 to inlet volume 600. A second fluid 604 is input through a second inlet port 640 to inlet volume 600 as well. The first and second inlet ports 610, 640 are located at different positions in the body of inlet volume 600, for example, one being at the end of the inlet volume 600 and the other being in a side wall of inlet volume 600.

Once the first and second fluids have entered the cavitation chamber 60 they are allowed to mix with one another. The first and second fluids mix at a desired location in the chamber 60. For example, the first and second fluids may undergo mechanical mixing as well as enhanced mixing due to the cavitation in cavitation zone 612 of the chamber. The fluid 606 exits after mixing and cavitation have taken place. As mentioned above, the entire fluid flow, mixing, and cavitation processes may take place under a static or baseline pressure, e.g., a positive, greater than ambient pressure, and the static pressure can be provided by a pump or gas loading apparatus.

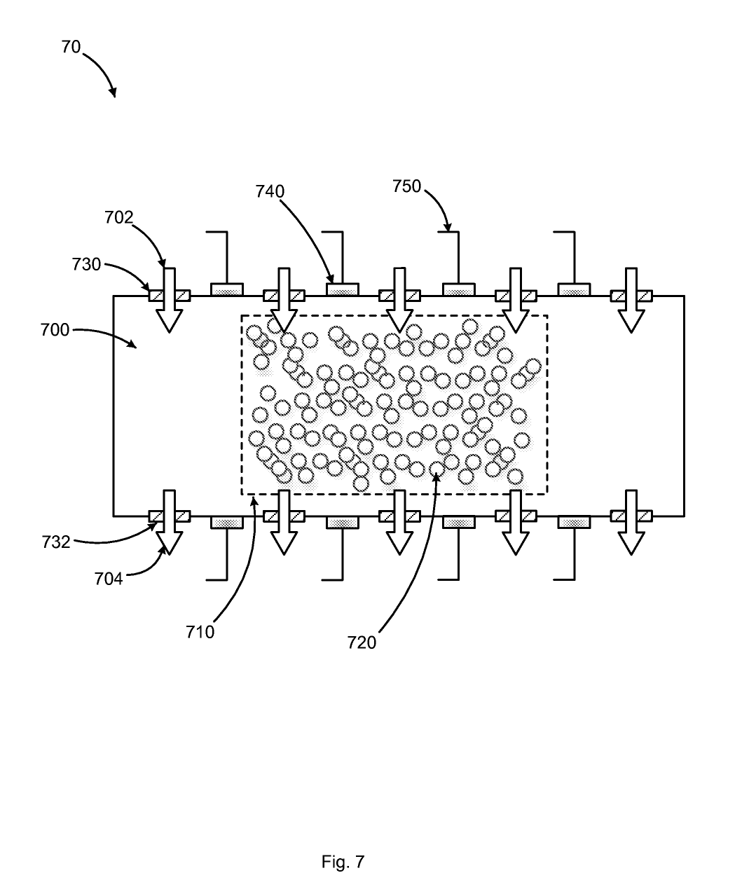

FIG. 7 illustrates yet another embodiment of a cavitation chamber 70 equipped with a plurality of inlet ports 730 and outlet or discharge ports 732. Acoustic transducers 740 are driven by driving signals on lines 750 as appropriate, and the driving of the transducers can be accomplished as discussed earlier.

Once the fluid 702 comes into the chamber 700 it undergoes cavitation in cavitation zone 710 and yields a plurality of bubbles 720 in cavitation zone 710. In this embodiment, the flow generally crosses (flows across) the chamber in a direction perpendicular to the long axis of symmetry of the chamber.

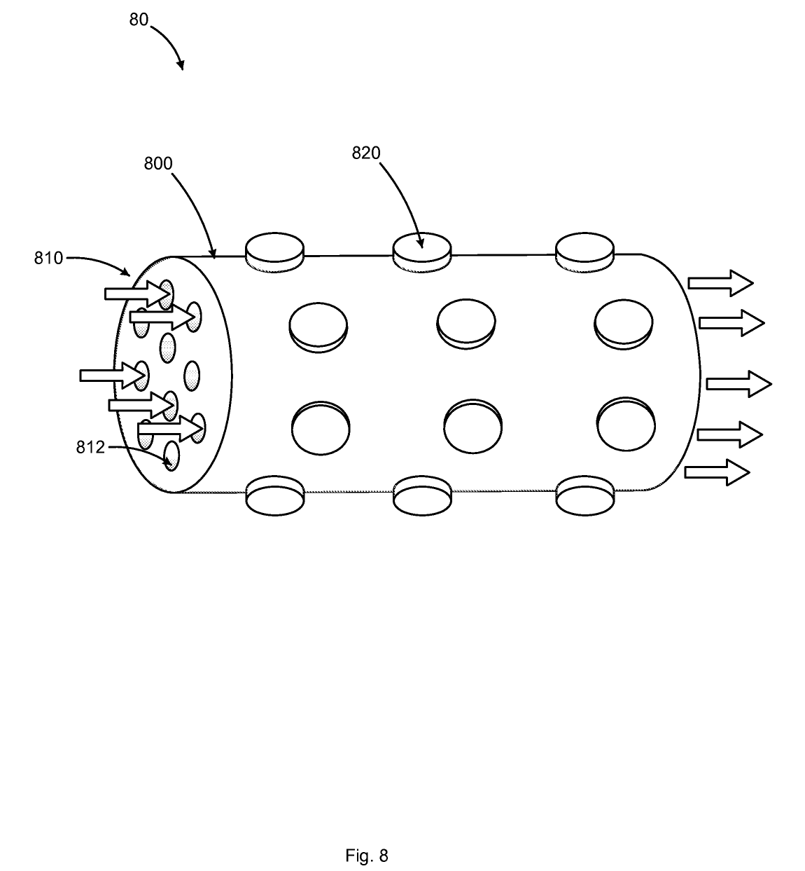

FIG. 8 illustrates a cavitation chamber 80 having a generally cylindrical metal shell 800. To the metal shell 800 are attached a plurality of acoustic drivers or transducers 820. Fluid 810 to undergo cavitation enters the chamber through a plurality of inlet ports 812. The inlet ports may be in fluid communication with an inlet plenum. Similar outlet ports may deliver the output fluid at the exit end of the chamber through a similar outlet plenum. Once again, as with other embodiments described herein, the entire fluid system, or the portions thereof that are experiencing cavitation in chamber 80 may be provided with a static fluid pressure so that the cavitation takes place under a baseline or bias static fluid pressure.

The selection of the locations for the fluid ports may be made at least in part relative to the locations of the acoustical driving transducers on the body of the cavitation chambers. Also, the selection of the location ports may be made at least in part relative to the locations of a characteristic feature of the acoustic fields within the cavitation chambers.

The present fluid ports can be constructed as necessary for a given application. In some embodiments, the fluid ports of the preceding drawings are formed by tapping a threaded opening into a selected location in a wall of the cavitation chambers. Fittings and sealants and gaskets may be employed to form fluid-tight seals in the fluid ports. The fluid-tight seals may be constructed and designed to withstand a substantial positive net pressure within said cavitation chambers. Steel, titanium or other metal alloys may be employed to make such fittings for structural integrity.

As discussed in this disclosure, the fluid within the cavitation chamber may be placed under a static or DC pressure that is greater than the atmospheric ambient pressure of the system. In some aspects, pre-pressurizing the fluid in the cavitation chambers will cause a more violent cavitation bubble collapse, and more favorable reactions driven by said cavitation are encouraged.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications.

What is claimed is:

1. An acoustic cavitation system, comprising:
an electrical driving circuit including a signal generator adapted to generate an electrical signal and an amplifier adapted to receive the electrical signal and generate an amplified driving signal for driving a plurality of transducer elements with respective driving signals at respective amplitudes thereof;
a data processor coupled to said electrical driving circuit adapted for executing a sequence of programmed instructions and for controlling an operation of said electrical driving circuit;
said plurality of transducer elements adapted to receive said respective driving signals and to provide respective acoustic outputs corresponding to the driving signals and amplitudes thereof;
a resonator having resonator walls capable of withstanding a greater than ambient static pressure within said resonator, and comprising at least one fluid inlet port and at least one fluid discharge port, said resonator walls coupled to said plurality of transducer elements such that the acoustic outputs of said transducer elements cause an acoustic field in a volume defined by said resonator walls, and such that a given driving signal and amplitude configuration is adapted to cause cavitation within a fluid within said resonator;
a fluid driving element adapted and arranged to cause flow of a fluid through said resonator, said flow being directed into at least one fluid inlet port of said resonator and exiting said resonator through at least one fluid discharge port; and
a fluid pressure source adapted and arranged to cause a net positive static pressure within said resonator, operating cooperatively with said fluid driving element, such that a fluid flowing through said resonator experiences flow, pressure, and cavitation effects within said resonator in some or all of the volume defined by said resonator walls.

2. The system of claim 1, said resonator being constructed of metal walls to withstand at least said net positive static pressure.

3. The system of claim 2, said metal walls comprising a steel composition.

4. The system of claim 1, further comprising a pressure sensor to sense said net positive static pressure.

5. The system of claim 4, further comprising a relief valve for relieving pressure within the cavitation system if said net positive static pressure exceeds a predetermined limit.

6. The system of claim 1, further comprising a shield surrounding said cavitation system so that an accidental discharge or explosion from said system caused by failure under excess net positive static pressure is at least partially contained by said shield.

7. The system of claim 1, said acoustic transducers being placed in predetermined configurations relative to a placement of said fluid ports in said resonator.

8. The system of claim 1, said acoustic transducers, said fluid inlet and discharge ports, and said acoustic field within said resonator all being configured and arranged for optimal processing of a flowing fluid within said resonator.

9. The system of claim 1, said resonator comprising a generally cylindrical body and having said plurality of transducers arranged in a circular symmetry about a circumference of said cylindrical body and extending along at least an axial portion along a length of said cylindrical body of said resonator.

10. The system of claim 1, said transducers being arranged, configured, driven and arranged to cause cavitation within a volume equaling five percent (5%) or more of the volume defined by the walls of said resonator.

11. The system of claim 1, said transducers being configured, driven and arranged to excite at least a longitudinal acoustic mode within the acoustic field in said resonator.

12. The system of claim 1, said transducers being configured, driven and arranged to excite at least a radial acoustic mode within the acoustic field in said resonator.

13. The system of claim 1, said transducers being configured, driven and arranged to excite at least a longitudinal acoustic mode and a radial mode within the acoustic field in said resonator.

14. A cavitation system for causing cavitation in a cavitation chamber of said system, comprising:
a cavitation chamber having rigid walls thereof;
a first fluid inlet port in an inlet volume of said chamber for receiving a first fluid or mixture;
a second fluid inlet port in said inlet volume of said chamber for receiving a second fluid or mixture;
a mixing zone in which said first and second fluids or mixtures are mixed with one another;
a plurality of acoustic drivers coupled to said rigid walls of said chamber for causing cavitation in a cavitation zone within said cavitation chamber, said cavitation zone being substantially in a portion of said chamber in which said mixing zone is located; and
at least one fluid outlet port in an outlet volume of said cavitation chamber for discharging the first and second fluids or mixtures after they have undergone mixing and cavitation.

15. The system of claim 14, further comprising a pump for moving said first fluid or mixture through said system.

16. The system of claim 14, further comprising a pump for moving said second fluid or mixture through said system.

17. The system of claim 14, further comprising a pressurizer for applying a static pressure substantially at said cavitation zone.

18. The system of claim 17, said pressurizer comprising a pump that pumps up one or both of the first and second fluids or mixtures to a given static pressure.

19. The system of claim 17, said pressurizer comprising a gas loading vessel for pressurizing one or both of the first and second fluids or mixtures to a given static pressure.
